(19) United States
(12) Patent Application Publication
(10) Pub. No.: US 2007/0008409 A1
(43) Pub. Date: Jan. 11, 2007

(54) CLOSED CIRCUIT TELEVISION

(76) Inventor: JAE-WOONG YOO, Uijeongbu-si Gyeonggi-do (KR)

Correspondence Address: IPLA P.A., 3580 WILSHIRE BLVD., 17TH FLOOR, LOS ANGELES, CA, 90010, US

(21) Appl. No.: 11/307,648

(22) Filed: Feb. 15, 2006

(30) Foreign Application Priority Data
Jul. 5, 2005 (KR) 10-2005-0060246

(51) Int. Cl. H04N 7/18; H04N 5/33

(52) U.S. Cl. 348/143; 348/164

(57) ABSTRACT

Disclosed herein is a Closed Circuit Television (CCTV). The CCTV includes a monitoring camera unit, two infrared projector units, and a direction adjustment means. The monitoring camera unit has a camera for imaging subjects and a plurality of infrared projection modules arranged around the camera. The two infrared projector units are arranged beside the monitoring camera unit, each including a plurality of infrared projection modules. The direction adjustment means is installed under a portion of a base plate on which the monitoring camera unit and the infrared projection units are mounted and configured to orient the monitoring camera in a desired direction. Accordingly, long-distance images can be observed at night by aligning infrared rays and an image observation point, and a wide range of images can be observed at night by preventing the range of an image captured by the camera and an infrared region from being mismatched.

### TECHNICAL FIELD

The present invention relates generally to a closed circuit television having infrared projectors and, more particularly, to a closed circuit television, which increases a capture distance based on infrared rays using a plurality of infrared projection modules that condense infrared rays through two steps, which provides a camera at a location surrounded by the plurality of infrared projection modules and causes the camera and the infrared rays to simultaneously move at the same angle, thus aligning infrared rays and an image observation point, so that long-distance images can be observed at night, and which prevents the ranges of images captured by the camera, and a infrared region from being mismatched when infrared projector units are arranged beside the monitoring camera unit and the direction of the monitoring camera unit is adjusted by a direction adjustment means, thus enabling image observation in a wide range.

### BACKGROUND ART

Generally, places, such as houses, department stores, banks, and exhibition halls, at which security is required are provided with Closed Circuit TeleVisions (CCTVs) to warn of and prevent disaster, including intrusion, theft and fire, or to enable swift response to the disaster.

Furthermore, recently, a number of CCTVs are installed even at underground parking lots in which crimes frequently occur, or along roads to control illegal parking.

Such a CCTV enables the capture of images using infrared Light Emitting Diodes (LEDs) at night when light is faint, or even in places at which illumination does not exist or is weak.

However, in the conventional CCTV using infrared rays, only the shortest distances can be illuminated because its power consumption is high and light is faint due to the small amount of the light, so that only subjects within a range of 2 to 3 m can be sensed and imaged.

That is, the conventional CCTV is problematic in that it is insufficient to function as a monitoring camera because it is difficult to capture long-distance images.

### DISCLOSURE

### Technical Problem

Accordingly, the present invention has been made keeping in mind the above problems occurring in the prior art, and an object of the present invention is to provide a CCTV, which increases a capture distance based on infrared rays using a plurality of infrared projection modules that condense infrared rays through two steps, which provides a camera at a location surrounded by the plurality of infrared projection modules and causes the camera and the infrared rays to simultaneously move at the same angle, thus aligning infrared rays and an image observation point, so that long-distance images can be observed at night, and which prevents the ranges of images captured by the camera, and a infrared region from being mismatched when infrared projector units are arranged beside the monitoring camera unit and the direction of the monitoring camera unit is adjusted by a direction adjustment means, thus enabling image observation in a wide range.

### Technical Solution

In order to accomplish the above object, the present invention is to provide a CCTV, including a monitoring camera unit having a camera for imaging subjects and a plurality of infrared projection modules arranged around the camera; two infrared projector units arranged beside the monitoring camera unit, each including a plurality of infrared projection modules; and a direction adjustment means installed under a portion of a base plate on which the monitoring camera unit and the infrared projection units are mounted and configured to orient the monitoring camera in a desired direction.

Furthermore, each of the infrared projector units may include an infrared LED module having an infrared LED and a primary condenser lens for condensing an infrared ray, which is emitted from the infrared LED, within a first angular range; and a secondary condenser lens for condensing the infrared ray, which is emitted from the infrared LED module, within a second angular range and emitting the condensed infrared rays.

Furthermore, it is preferred that the first angular range be ±13°, the second angular range be one of ±5° and ±10°, and the infrared LED be a hybrid type LED.

Furthermore, it is preferred that the primary condenser lens be a reflector type condenser lens.

Furthermore, the monitoring camera unit and the infrared projection units are provided with light sensors so as to turn off the infrared LED modules when the sensed intensity of illumination is higher than a predetermined intensity of illumination, thus minimizing power consumption, and turn on the infrared LED modules when the sensed intensity of illumination is lower than the predetermined intensity of illumination.

Furthermore, the camera of the monitoring camera unit images a subject in color using a color filter when the sensed intensity of illumination is higher than the predetermined intensity of illumination, and converts the color filter into a black and white filter and images a subject in black and white when the sensed intensity of illumination is lower than the predetermined intensity of illumination, thus facilitating image observation.

Furthermore, the monitoring camera unit is provided with a high temperature sensor and a low temperature sensor so as to operate a blower when a sensed temperature is higher than a first temperature, thus reducing the temperature of the CCTV, and turn on the infrared LED modules when the sensed temperature is lower than a second temperature, thus increasing the temperature of the CCTV.

Furthermore, the monitoring camera unit and the infrared injector units may further include a switching mode power supply for converting supplied power into a constant voltage and outputting the constant voltage, thus lengthening the life spans of the infrared projection modules and the camera.

### Advantageous Effects

The present invention can provide a CCTV, which increases a capture distance based on infrared rays using a plurality of infrared projection modules that condense infrared rays through two steps, which provides a camera at a location surrounded by the plurality of infrared projection modules and causes the camera and the infrared rays to simultaneously move at the same angle, thus aligning infrared rays and an image observation point, so that long-distance images can be observed at night, and which prevents the ranges of images captured by the camera, and a infrared region from being mismatched when infrared projector units are arranged beside the monitoring camera unit and the direction of the monitoring camera unit is adjusted by a direction adjustment means, thus enabling image observation in a wide range.

### DESCRIPTION OF DRAWINGS

FIG. 1 is a perspective view showing a CCTV according to an embodiment of the present invention;

FIG. 2 is a front view showing the CCTV according to the embodiment of the present invention;

FIG. 3 is an exploded view showing the infrared projection module of the CCTV according to the embodiment of the present invention;

FIG. 4 is a view illustrating the effect of the infrared projection module of the CCTV according to the embodiment of the present invention; and

FIG. 5 is an exploded perspective view showing the monitoring camera unit of the CCTV according to the embodiment of the present invention.

### BEST MODE

A preferred embodiment of the present invention is described in detail with reference to the accompanying drawings below.

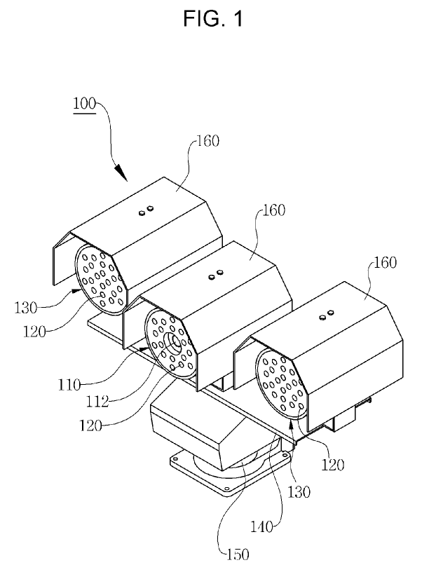

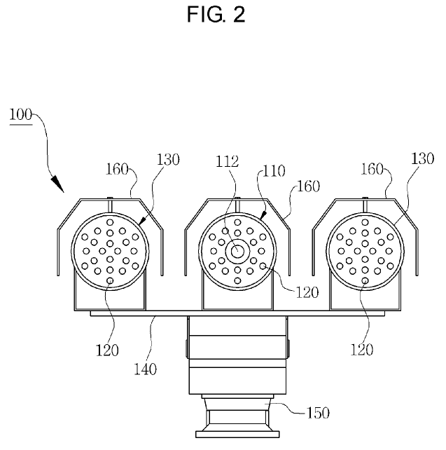

FIG. 1 is a perspective view showing a CCTV according to an embodiment of the present invention. FIG. 2 is a front view showing the CCTV according to the embodiment of the present invention.

Referring to FIGS. 1 and 2, the CCTV 100 according to the embodiment of the present invention includes a single monitoring camera unit 110 and two infrared projector units 130 arranged beside the monitoring camera unit 110.

The monitoring camera unit 110 includes a camera 112 for capturing the images of subjects and a plurality of infrared projection modules 120, and each of the infrared projector units 130 includes a plurality of infrared projection modules 120.

The monitoring camera unit 110 is configured such that the camera 112 is mounted at a location surrounded by the plurality of infrared projection modules 120 and, thus, the camera 112 and infrared rays simultaneously move at the same angle. Accordingly, it is preferred that the monitoring camera unit 110 be configured such that the infrared rays and an image observation point are aligned and, thus, long-distance images can be observed at night.

Furthermore, the CCTV 100 according to the embodiment of the present invention further includes a base plate 140 configured to couple the monitoring camera unit 110 with the infrared projector units 130 and to fasten the monitoring camera unit 110 and the infrared projector units 130 thereto, a direction adjustment means 150 coupled to the lower portion of the base plate 140 to adjust the direction of the CCTV 100, and covers 160 configured to cover the monitoring camera unit 110 and the infrared projector units 130, respectively.

Furthermore, when the existing CCTV independently rotates and captures an image, the boundary portion of the captured image is dark. Unlike this, the monitoring camera unit 110 of the present invention is arranged between the infrared projector units 130, so that the range of an image, which is captured by the camera 112 and the range of an infrared region are prevented from being mismatched and, therefore, a wide range of images can be observed.

Furthermore, when a plurality of infrared projection modules 120 is applied to the monitoring camera unit 110 and the infrared projector units 130, even long-distance images can be clearly captured.

Furthermore, the direction adjustment means 150 is formed under the base plate 140, and adjusts the CCTV 100 so that the CCTV 100 is directed in a desired direction by adjusting the direction in which the base plate 140 is oriented. The direction adjustment means 150 receives a direction signal from a user through a remote controller (not shown).

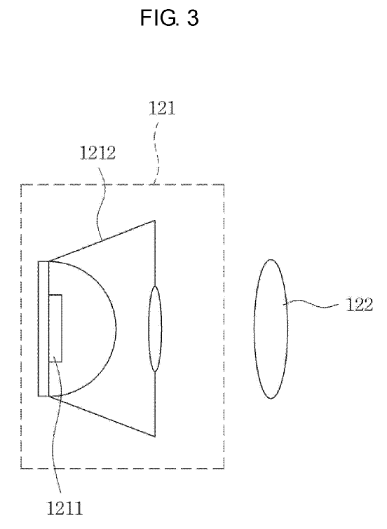

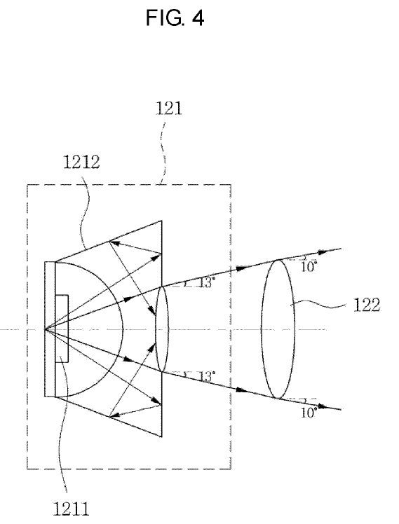

FIG. 3 is an exploded view showing the infrared projection module of the CCTV according to the embodiment of the present invention, and FIG. 4 is a view illustrating the effect of the infrared projection module of the CCTV according to the embodiment of the present invention.

Referring to FIGS. 3 and 4, each of the infrared projection modules 120 includes an infrared LED module 121 and a secondary condensing lens 122.

The infrared LED module 121 includes an infrared LED 1211 and a first condensing lens 1212 for condensing an infrared ray emitted from the infrared LED 1211 within the range of a first angular angle.

It is preferred that the infrared LED 1211 be configured using a first-order hybrid type LED to acquire a large amount of light.

Furthermore, it is preferred that the primary condenser lens 1212 be reflector type condenser lens.

The infrared LED module 121 primarily condenses an infrared ray emitted from the infrared LED 1211 within ±13° and then the infrared ray, which is condensed within ±13°, are secondarily condensed within ±10° by the secondary condensing lens 122 that is visible from outside the CCTV 100, and the secondarily condensed infrared ray is then emitted to the outside. Accordingly, the loss of the infrared ray emitted from the infrared LED 1211, is minimal and, therefore, an image a maximal distance of which exceeds a range of 200 m to 1 km can be observed even under less than a predetermined intensity of illumination (10.0 Lux).

In this case, it is preferred that the secondarily condensed infrared ray be condensed within an angular range of ±5° according to the manipulation of a user. FIG. 4 is a view showing an example in which the secondarily condensed infrared ray are condensed within an angular range of ±10°.

In this case, when the amount of light is small, it is preferred that a capture distance, which can be observed by the CCTV 100, be lengthened in proportion to the number of the infrared projection modules 120 used.

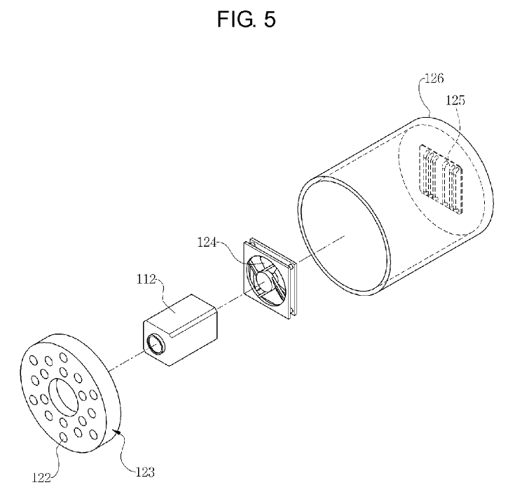

FIG. 5 is an exploded perspective view showing the monitoring camera unit 110 of the CCTV according to the embodiment of the present invention.

Referring to FIG. 5, the monitoring camera unit 110 includes an infrared projector mounting element 123 configured to be capable of mounting the infrared projection modules 120, the camera 112 for capturing images, a blower 124 for lowering the temperature of the camera 112, a wide range power supply 125 for outputting a voltage of 12 V from power supplied to the camera 112, and a casing 126 configured to mount the camera 112, the blower 124, and the wide range power supply 125 and to be coupled with the infrared projector mounting element 123.

Each of the infrared projector units 130 is configured in such a way as to remove the camera 112 from the monitoring camera unit 110 and densely mount the infrared projection modules 120 on the infrared projector mounting element 123.

It is preferred that light sensors (CdS sensors, not shown) are provided on the monitoring camera unit 110 and the infrared projector units 130 and sense the intensity of illumination, so that the infrared LED modules 121 may be turned off at an illumination intensity of more than 10.0 Lux and, therefore, unnecessary power consumption is reduced, but the infrared LED modules 121 may be turned on at an illumination intensity of less than 10.0 Lux.

It is preferred that each of the light sensors be formed using a CdS photoconductive cell, the main component of which is cadmium sulfide CdS, and which has a characteristic in that the internal resistance thereof varies according to incident light energy.

The CdS photoconductive cell has a low resistance value in proportion to incident light energy. That is, when no light is incident, the CdS photoconductive cell almost becomes an insulator. In contrast, when light is incident, the CdS photoconductive cell allows current to pass through it because the internal resistance thereof is reduced. Such a characteristic results in the effect that streetlights are turned on in the nighttime and are turned off in the daytime, or that, in the case where the CdS photoconductive cell is used for lamps for the stairs of apartments, the lamps are automatically turned on when persons pass through the stairs and are then turned off after a predetermined time, and are not turned on in the daytime. Accordingly, the light sensor of the present invention also employs the principle of the effects.

Furthermore, the infrared LED modules 121 are turned off when light is bright (more than 10.0 Lux) and, at the same time, the camera 112 captures an image in color. In contrast, the infrared LED modules 121 are turned on at night (less than 10.0 Lux), changes the function of the camera 112 from color to black and white, and a color filter is converted into a black and white filter (glass filter), so that 100% of infrared rays can be absorbed and, therefore, image capture can be facilitated.

It is preferred that high temperature sensors and low temperature sensors (not shown) are provided on the monitoring camera unit 110 and the infrared projector units 130, and allow the blower 124 to operate at a high temperature of more than +35° C., thus lowering the temperatures of the monitoring camera unit 110 and the infrared projector units 130. Furthermore, it is preferred that, even when the intensity of illumination is higher than 10.0 Lux at a low temperature of less than +15° C., The infrared LED modules 121 are turned on and, therefore, the temperature of the CCTV 100 increases, so that the CCTV can operate within a range from −30° C. to +55° C.

The monitoring camera 100 of the present invention is provided with a Switching Mode Power Supply (SMPS) 125 to supply stable power. In the case of Direct Current (DC), the wide range power supply 125 causes its output voltage to remain constant at DC 12 V when a voltage within a range of +9 V to +18 V is input, thus stably driving the CCTV 100 and stably driving the camera 112 and the infrared projection module 120. Accordingly, the life span of the CCTV 100 can be lengthened to more than five years. Furthermore, in the case of Alternating Current (AC), the SMPS 125 keeps its output voltage constant at DC 12 V when an AC voltage within a range of 90 V to 240 V is input, thus driving the CCTV 100.

Although the present invention has been described in detail in conjunction with the preferred embodiment, the scope of the present invention is not limited to the above-described preferred embodiment, and must be appreciated based on the appended claims. Furthermore, those skilled in the art should appreciate that various modifications and variations are possible without departing from the scope and spirit of the present invention.

What is claimed is:

1. A Closed Circuit Television (CCTV), comprising:
a monitoring camera unit comprising a camera for imaging subjects and a plurality of infrared projection modules arranged around the camera;
two infrared projector units arranged beside the monitoring camera unit, each comprising a plurality of infrared projection modules; and
direction adjustment means installed under a portion of a base plate on which the monitoring camera unit and the infrared projection units are mounted and configured to orient the monitoring camera in a desired direction.

2. The CCTV as set forth in claim 1, wherein each of the infrared projection modules comprises:
an infrared Light-Emitting Diode (LED) module comprising an infrared LED and a primary condenser lens for condensing an infrared ray, which is emitted from the infrared LED, within a first angular range; and
a secondary condenser lens for condensing the infrared ray, which is emitted from the infrared LED module, within a second angular range and emitting the condensed infrared rays.

3. The CCTV as set forth in claim 2, wherein the first angular range is ±13°, the second angular range is one of ±5° and ±10°, and the infrared LED is a hybrid type LED.

4. The CCTV as set forth in claim 2, wherein the monitoring camera unit and the infrared projection units are provided with light sensors so as to turn off the infrared LED modules when sensed intensity of illumination is higher than a predetermined intensity of illumination, thus minimizing power consumption, and turn on the infrared LED modules when the sensed intensity of illumination is lower than the predetermined intensity of illumination.

5. The CCTV as set forth in claim 4, wherein a camera of the monitoring camera unit images a subject in color using a color filter when the sensed intensity of illumination is higher than the predetermined intensity of illumination, and converts the color filter into a black and white filter and images a subject in black and white when the sensed intensity of illumination is lower than the predetermined intensity of illumination, thus facilitating image observation.

6. The CCTV as set forth in claim 5, wherein the monitoring camera unit is provided with a high temperature sensor and a low temperature sensor so as to operate a blower when a sensed temperature is higher than a first temperature, thus reducing a temperature of the CCTV, and turn on the infrared LED modules when the sensed temperature is lower than a second temperature, thus increasing the temperature of the CCTV.

7. The CCTV as set forth in claim 6, wherein the monitoring camera unit and the infrared injector units further comprise a switching mode power supply for converting supplied power into a constant voltage and outputting the constant voltage, thus lengthening life spans of the infrared projection modules and the camera.

8. The CCTV as set forth in claim 2, wherein the primary condenser lens is a reflector type condenser lens.
